(19) United States
(12) Patent Application Publication
(10) Pub. No.: US 2012/0211213 A1
(43) Pub. Date: Aug. 23, 2012

(54) HEAT SINK AND METHOD OF MANUFACTURING THE SAME

(75) Inventor: Hironori KITAJIMA, Tsuchiura (JP)

(73) Assignee: Hitachi Cable, Ltd., Tokyo (JP)

(21) Appl. No.: 13/312,851

(22) Filed: Dec. 6, 2011

(30) Foreign Application Priority Data
Feb. 21, 2011 (JP) 2011-034660

(51) Int. Cl. F28F 7/00; B32B 37/14; B32B 38/04; B32B 37/02

(52) U.S. Cl. 165/185; 156/242

(57) ABSTRACT

A heat sink includes a laminated body disposed in a flow path for circulating a refrigerant. The laminated body includes a metallic tube body enclosing the flow path therein, an insulation layer formed on a periphery of the tube body, and a conductor that is formed on a periphery of the insulation layer and includes a bonding surface bonded to an electrode of a semiconductor device to be cooled.

The present application is based on Japanese Patent Application No 2011-034660 filed on Feb. 21, 2011, the entire contents of which are incorporated herein by reference.

### BACKGROUND OF THE INVENTION

1. Field of the Invention

The invention relates to a heat sink used for cooling a semiconductor device and a method of manufacturing the same.

2. Description of the Related Art

Conventionally, various heat sinks have been proposed to stabilize the operation of a semiconductor device (see, e.g., JP-A-2006-165165).

JP-A-2006-165165 discloses a heat sink that a copper perforated body having plural refrigerant-passing holes is arranged in an internal space of a copper heat sink main body. A semiconductor device is mounted on a surface of the heat sink main body and a refrigerant passes from one side to another of the refrigerant-passing hole of the perforated body, hence, heat conducted from the semiconductor device to the perforated body via the heat sink main body is dissipated into the refrigerant which passes through the refrigerant-passing hole. It is considered that the larger the number of the refrigerant-passing holes, the more an area of the perforated body in contact with the refrigerant increases, which increases heat radiation amount and improves heat radiation efficiency.

### SUMMARY OF THE INVENTION

However, the conventional heat sink can be used only for a semiconductor device with electrodes formed on the surface opposite the bonding surface with the heat sink so as not to electrically connect the electrode of the semiconductor device to a refrigerant flowing in the heat sink when the semiconductor device is directly bonded to the heat sink main body.

Accordingly, it is an object of the invention to provide a heat sink with high cooling performance in which an outer layer is configured to concurrently serve as an electrode for applying pressure to a semiconductor device, and a method of manufacturing the same.

(1) According to one embodiment of the invention, a heat sink comprises:

a laminated body disposed in a flow path for circulating a refrigerant,

wherein the laminated body comprises a metallic tube body enclosing the flow path therein, an insulation layer formed on a periphery of the tube body, and a conductor that is formed on a periphery of the insulation layer and comprises a bonding surface bonded to an electrode of a semiconductor device to be cooled.

In the above embodiment (1) of the invention, the following modifications and changes can be made.

(i) The heat sink further comprises:

an electrode body that is attached to a surface of the conductor and electrically connected to the semiconductor device via the conductor.

(ii) A plurality of the laminated bodies are arranged in parallel.

(iii) The plurality of the laminated bodies comprise the bonding surface on an opposite side of a pair of the conductors.

(iv) The plurality of the laminated bodies comprise the bonding surface on a same side of the conductors.

(v) The laminated body comprises a plurality of the conductors arranged along a longitudinal direction thereof and electrically insulated from each other.

(vi) The laminated body comprises a plurality of conductor regions that are provided on a same side of the conductor and electrically insulated from each other, the plurality of conductor regions each comprising the bonding surface.

(vii) The tube body is an internally grooved tube.

(viii) The laminated body comprises a plurality of the tube bodies disposed in a plurality of the flow paths, the single insulation layer formed on the periphery of the plurality of the tube bodies, and the conductor formed on the periphery of the single insulation layer.

(ix) The laminated body comprises the single tube body disposed in a plurality of flow paths, the single insulation layer formed on the periphery of the single tube body, and the single conductor formed on the periphery of the single insulation layer.

(2) According to another embodiment of the invention, a method of manufacturing a heat sink comprises:

forming an elongated laminated body through a drawing process, the laminated body comprising a metallic tube body enclosing a flow path therein, an insulation layer formed on a periphery of the tube body and a conductor formed on a periphery of the insulating layer;

removing a portion of the conductor; and

cutting the elongated laminated body.

Points of the Invention

According to one embodiment of the invention, a heat sink is constructed such that an electrode of a semiconductor device is directly bonded to a bonding surface of a conductor (i.e., the outermost layer) of the heat sink using a solder, and the conductor is electrically insulated from a tube body by an insulation layer disposed between the tube body and the conductor. Therefore, heat generated from the semiconductor device can be transmitted to the tube body from the periphery of the conductor, so that the high cooling performance of the heat sink can be obtained. Furthermore, the electrode of the semiconductor device can be surely insulated from a refrigerant flowing in the tube body to ensure the safety in operation. Therefore, the heat sink of the embodiment can be also used for a semiconductor device with electrodes formed on both sides thereof. In this case, the conductor of the heat sink can serve as an electrode.

### BRIEF DESCRIPTION OF THE DRAWINGS

Next, the present invention will be explained in more detail in conjunction with appended drawings, wherein:

FIG. 1 is a schematic cross sectional view showing a heat sink in a first embodiment of the invention;

FIG. 2A is a schematic plan view showing a heat sink in a second embodiment of the invention;

FIG. 2B is a cross sectional view cut along a line A-A in FIG. 2A;

FIG. 2C is a diagram showing an equivalent circuit of a system in the second embodiment;

FIG. 3A is a schematic cross sectional view showing a heat sink in a third embodiment of the invention;

FIG. 3B is a diagram showing an equivalent circuit of a system in the third embodiment;

FIG. 4 is a schematic cross sectional view showing a heat sink in a fourth embodiment of the invention;

FIG. 5A is a schematic cross sectional view showing a heat sink in a fifth embodiment of the invention;

FIG. 5B is a diagram showing an equivalent circuit of a system in the fifth embodiment;

FIG. 6 is a schematic plan view showing a heat sink in a sixth embodiment of the invention;

FIG. 7 is a schematic plan view showing a heat sink in a seventh embodiment of the invention;

FIG. 8 is a process chart schematically showing a process of removing a conductor in the seventh embodiment;

FIG. 9 is a schematic cross sectional view showing a heat sink in an eighth embodiment of the invention;

FIG. 10 is a cross sectional view showing a laminated body of a heat sink in a ninth embodiment of the invention;

FIG. 11A is a schematic cross sectional view showing a heat sink in a tenth embodiment of the invention;

FIG. 11B is an explanatory diagram illustrating a flow path structure of a system in the tenth embodiment;

FIG. 11C is an explanatory diagram illustrating another flow path structure of a system in the tenth embodiment;

FIG. 12 is a schematic cross sectional view showing a heat sink in an eleventh embodiment of the invention; and

FIG. 13 is a schematic perspective view showing a heat sink in a twelfth embodiment of the invention.

### DETAILED DESCRIPTION OF THE PREFERRED EMBODIMENTS

Embodiments of the invention will be described below in reference to the drawings. It should be noted that constituent elements having substantially the same function are denoted by the same reference numerals in each drawing and the overlapping explanation will be omitted.

### Embodiment

A heat sink in the embodiments includes a laminated body provided around a flow path for circulating a refrigerant, and in the heat sink, the laminated body is provided with a tube body formed of metal of which inside is the flow path, an insulation layer formed around the tube body, and a conductor which is formed around the insulation layer and has, on a surface thereof, a bonding surface bonded to an electrode of a semiconductor device to be cooled.

In the above-mentioned configuration, heat generated by the semiconductor device is transmitted to the bonding surface of the conductor, is further transmitted to the tube body via the insulation layer, and is dissipated into a refrigerant which flows in the flow path of the tube body. In addition, the heat generated by the semiconductor device is transmitted to the tube body from the periphery of the conductor, and high cooling performance is obtained by directly bonding the electrode of the semiconductor device to the bonding surface of the conductor using solder, etc. Furthermore, the electrode of the semiconductor device is not electrically conducted to the refrigerant flowing in the tube body since the conductor is electrically insulated from the tube body by the insulation layer, and safety is thus ensured. That is, it is possible to configure the conductor as an outer layer to also serve as an electrode.

### First Embodiment

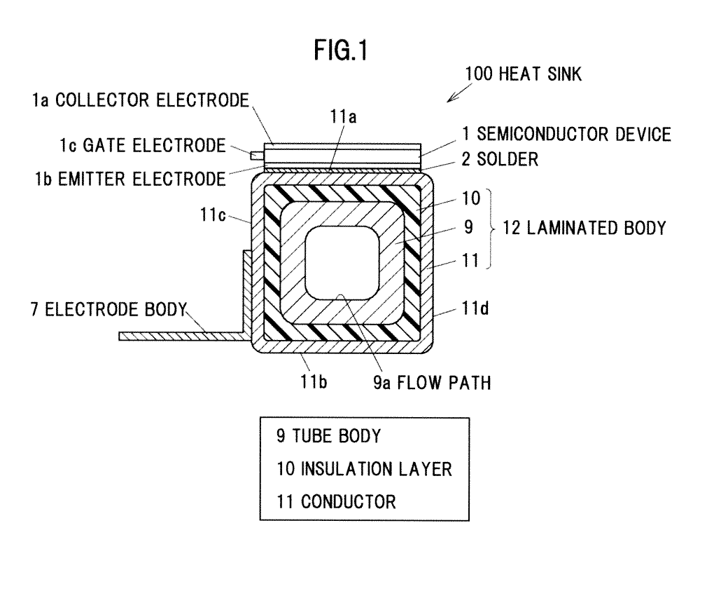

FIG. 1 is a schematic cross sectional view showing a heat sink in the first embodiment of the invention.

A heat sink 100 is composed of a laminated body 12 provided around a flow path 9a for circulating a refrigerant and an electrode body 7 electrically connected to a surface of the laminated body 12, and a semiconductor device 1 to be cooled is bonded to the surface of the laminated body 12 by a solder 2 as a bonding agent. The refrigerant used is, e.g., cold water. The material for bonding the semiconductor device 1 to the laminated body 12 is not limited to the solder 2. A conductive adhesive such as silver paste may be used in substitution for the solder 2, or other bonding methods not using a bonding agent, such as ultrasonic welding or room temperature bonding (a method in which clean surfaces are pressure-welded in vacuum at an atomic level) may be used. Heat transfer characteristics may be improved by not using a bonding agent.

Laminated Body

The laminated body 12 is provided with a tube body 9 of which inside is the flow path 9a, an insulation layer 10 formed on the outer surface of the tube body 9 and a conductor 11 formed on the outer surface of the insulation layer 10. The tube body 9, the insulation layer 10 and the conductor 11 are integrally formed.

The tube body 9 has a rectangular cross section (e.g., a square cross section). The heat transfer performance is enhanced when a thinner tube body 9 is used. The thickness of the tube body 9 is determined by taking into consideration processibility and attachability, etc. In the first embodiment, the thickness of the tube body 9 is, e.g., 1 to 7 mm. The flow path 9a has a square shape in cross-section and a size of one side thereof is, e.g., 4 to 20 mm. The tube body 9 is formed of, e.g., copper or a copper alloy from the viewpoint of thermal conductivity and electrical conductivity, but may be formed of another metal.

The thickness of the insulation layer 10 is determined depending on voltage applied to the semiconductor device 1 or electric current flowing in the tube body 9 and the conductor 11 even though heat-transfer performance is enhanced when a thinner insulation layer 10 is used. The thickness of the insulation layer 10 is, e.g., 1 to 4 mm. The insulation layer 10 is formed of, e.g., ceramic such as magnesium oxide from the viewpoint of electrical insulation and heat resistance. In other words, the ceramic is used as the material of the insulation layer 10, because there is less risk that the insulation layer 10 is deteriorated or damaged, etc., even if the bonded portion is heated or exposed to a high temperature during solder bonging of the semiconductor device 1. The insulation layer 10 is not limited to magnesium oxide, and other ceramics or heat resistant resins, etc., may be used depending on a method of attaching the semiconductor device 1 (including a temperature condition).

The conductor 11 has a rectangular cross section (e.g., a square cross section) which is composed of an upper surface 11a, a lower surface 11b and side surfaces 11c and 11d. In the first embodiment, the upper surface 11a serves as a bonding surface to be bonded to the semiconductor device 1. The thickness of the conductor 11 is determined depending on voltage applied to the semiconductor device 1 and/or electric current flowing in the conductor 11 even though heat-transfer performance is enhanced when a thinner conductor 11 is used. The thickness of the conductor 11 is, e.g., 0.5 to 3 mm. In addition, one side of the outer shape of the conductor 11 is, e.g., 7 to 35 mm in size. A size of a surface to be a bonding surface of the conductor 11 is determined in accordance with a size of a semiconductor device to be cooled or a size of an electrode. The upper surface (bonding surface) 11a of the conductor 11 to be bonded to the semiconductor device 1 is a flat surface so as to be easily bonded to the semiconductor device 1. Therefore, surfaces other than the bonding surface may be curved. The conductor 11 is formed of, e.g., copper or a copper alloy from the viewpoint of thermal conductivity and electrical conductivity, but may be formed of another metal.

Electrode Body

The electrode body 7 has, e.g., a L-shaped cross section. The electrode body 7 is formed of, e.g., copper or a copper alloy from the viewpoint of the electrical conductivity, but may be formed of another metal. The electrode body 7 is bonded to a surface of the conductor 11, which is the side surface 11c in the first embodiment, by soldering, brazing or ultrasonic welding, etc., and is electrically connected to the semiconductor device 1 via the conductor 11. A surface for attaching the electrode body 7 is not limited to the side surface 11c of the conductor 11, and the electrode body 7 may be attached to a region of the lower surface 11b or the other side surface 11d or the upper surface 11a other than the region to which the semiconductor device 1 is bonded. Also, the cross-sectional shape of the electrode body 7 is not limited to the L-shape, and the electrode body 7 may have a flat shape or other shapes.

Semiconductor Device

The semiconductor device 1 to be cooled can be, e.g., a power semiconductor device having a rated voltage of 200V or more and a rated current of 300 A or more, such as an insulated gate bipolar transistor (IGBT), a power MOSFET (Metal Oxide Semiconductor Field Effect Transistor), a bipolar-mode static induction Transistor (BSIT), etc., or can be a laser diode, etc., however, it is not limited thereto. In the first embodiment, an IGBT having, e.g., a rated voltage of 200V and a rated current of 300 A is used. The semiconductor device 1 of the IGBT is provided with a collector electrode 1a on the upper surface thereof, an emitter electrode 1b on the lower surface thereof and a gate electrode 1c on the side surface thereof. A positive terminal of a DC power supply is connected to the collector electrode 1a of the semiconductor device 1 via a metal wire (illustration omitted) and a negative terminal of the DC power supply is connected to the emitter electrode 1b via a metal wire (illustration omitted), the electrode body 7, the conductor 11 and the solder 2. The semiconductor device 1 of the IGBT has a size of, e.g., about 15 mm×30 mm.

The collector electrode 1a of the semiconductor device 1 is connected to the positive terminal of the DC power supply via a wiring. The emitter electrode 1b of the semiconductor device 1 is connected to the negative terminal of the DC power supply via the solder 2, the conductor 11 of the laminated body 12, the electrode body 7 and a wiring. The semiconductor device 1 is operated by inputting a control signal into the gate electrode 1c.

Method of Manufacturing Laminated Body

Next, an example of a method of manufacturing the laminated body 12 will be explained. In the first embodiment, a drawing process as described below is performed to manufacture the laminated body. Firstly, a circular cross-sectional conductor and tube body, each having a predetermined outer diameter and thickness, and an insulator formed by molding magnesium oxide powder into a cylinder having a predetermined outer diameter and thickness are prepared, and then, the insulator and the tube are inserted into the conductor in a concentric manner, thereby forming a laminated body.

Next, in a state that a plug is passed through a hollow portion in the tube body of the laminated body, a drawing process is performed by passing the laminated body through a die having a square hole in which each side slightly bulges outward in the middle, and annealing is subsequently performed. As a result, the laminated body (still an intermediate body) has a square cross section in which each side slightly bulges outward in the middle.

Next, in a state that the plug is passed through the hollow portion, a drawing process is performed by passing the laminated body (still an intermediate body) through a die having a square hole which is equal to a product dimension. As a result, the laminated body 12 having a cross section shown in FIG. 1 is obtained. A completed product elongated to, e.g., 60 m or more is obtained by subsequent annealing, and is then cut into a required length.

Although the formation is carried out by performing the drawing process twice in the above description of the manufacturing method, the number of the drawing processes and the annealing may be increased. Meanwhile, the drawing process is performed while the plug is passed through the hollow portion of the tube body in the above description of the manufacturing method, however, the drawing process may be performed without inserting the plug. When the plug is not inserted, it is possible to draw in a coiled shape, which facilitates to obtain an elongated product.

Operation of Heat Sink

The semiconductor device 1 generates heat by being operated. The heat generated by the semiconductor device 1 is transmitted to the upper surface 11a as a bonding surface of the conductor 11, is further transmitted to the tube body 9 via the insulation layer 10, and is dissipated into the refrigerant which flows in the flow path 9a of the tube body 9. The heat generated by the semiconductor device 1 is transmitted to the tube body 9 from the periphery of the conductor 11, and thus, high cooling performance is obtained by directly bonding the emitter electrode 1b of the semiconductor device 1 to the upper surface 11a as a bonding surface of the conductor 11 using the solder 2. Furthermore, the emitter electrode 1b of the semiconductor device 1 is not electrically conducted to the refrigerant flowing in the tube body 9 since the conductor 11 is electrically insulated from the tube body 9 by the insulation layer 10, and safety is thus ensured. That is, it is possible to configure the conductor 11 to also serve as an electrode. The refrigerant flows in the flow path 9a, and the heat held by the refrigerant is dissipated into the air when the refrigerant passes through a heat radiator (illustration omitted) composed of a pump, a radiator and a fan, etc., or through a freezing machine (illustration omitted), etc.

### Effects of the First Embodiment

The following effects are obtained by the first embodiment.

(a) Since the respective layers of the laminated body 12 can be easily integrated by the drawing process and it is possible to form an elongated laminated body 12 with a length of 60 m or more, it is possible to manufacture the present heat sink at low cost only by cutting an elongated material into a predetermined length.

(b) Since the tube body 9 is insulated from the conductor 11 by insulation layer 10, there is no risk that high voltage is applied to the water as a refrigerant. Only by using the laminated body 12 as an electrode as well as a heat sink, there is no need to provide a special structure for insulation, unlike the conventional structure.

### Second Embodiment

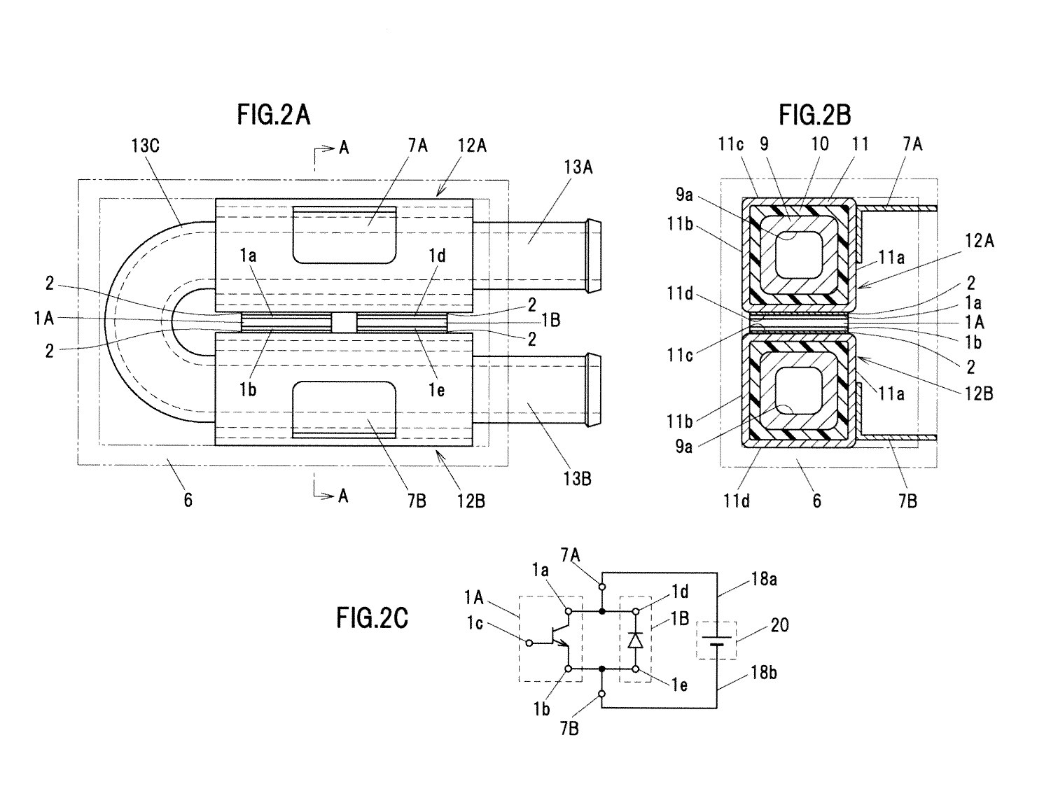

FIG. 2A is a schematic plan view showing a heat sink in the second embodiment of the invention. FIG. 2B is a cross sectional view taken along a line A-A in FIG. 2A. Note that, illustration of a gate electrode 1c of a semiconductor device 1A is omitted in FIGS. 2A and 2B (the same is applied to the following drawings).

In the second embodiment, a pair of laminated bodies 12A and 12B are arranged in parallel and two semiconductor devices 1A and 1B are arranged between the pair of laminated bodies 12A and 12B. Bonding surfaces in the second embodiment are the side surface 11d of the conductor 11 of the laminated body 12A and the side surface 11c of the conductor 11 of the laminated body 12B.

A heat sink of the second embodiment is configured to include a pair of laminated bodies 12A and 12B arranged in parallel, a pair of piping materials 13A and 13B respectively connected to the end portions of the pair of laminated bodies 12A and 12B on one side, an arc-shaped piping material 13C connected at both of the end portions thereof to the end portions of the pair of laminated bodies 12A and 12B on another side, and a pair of electrode bodies 7A and 7B connected to the conductors 11 of the pair of laminated bodies 12A and 12B. The laminated bodies 12A and 12B, portions of the piping materials 13A and 13B, the piping material 13C and the pair of electrode bodies 7A and 7B are housed in a case 6.

The case 6 is formed of, e.g., an insulating material such as resin. The case 6 may be configured to be separable into, e.g., upper and lower cases, such that the upper case is attached to the lower case after the laminated bodies 12A, 12B, the piping materials 13A, 13B, 13C and the electrode bodies 7A and 7B are housed in the lower case.

The semiconductor device 1A is, e.g., an IGBT and is provided with the collector electrode 1a on the upper surface thereof, the emitter electrode 1b on the lower surface thereof and a gate electrode (illustration omitted) on the side surface thereof. The semiconductor device 1B is, e.g., a free wheel diode (FWD) and is provided with a cathode electrode 1d on the upper surface thereof and an anode electrode 1e on the lower surface thereof. The collector electrode 1a of the semiconductor device 1A as an IGBT is connected to the conductor 11 of the laminated body 12A by the solder 2, and the emitter electrode 1b of the semiconductor device 1A is connected to the conductor 11 of the laminated body 12B by the solder 2. The cathode electrode 1d of the semiconductor device 1B as a FWD is connected to the conductor 11 of the laminated body 12A by the solder 2, and the anode electrode 1e of the semiconductor device 1B is connected to the conductor 11 of the laminated body 12B by the solder 2.

The piping materials 13A and 13B are connected to the tube bodies 9 exposed at the end faces of the laminated bodies 12A and 12B on the one side, and the piping material 13C is connected to the tube bodies 9 exposed at the end faces of the laminated bodies 12A and 12B on the other side. This makes a refrigerant circulate through the piping material 13A, the laminated body 12A, the piping material 13C, the laminated body 12B and the piping material 13B. Note that, although a signal line and a positioning mechanism, etc., are arranged to configure the actual system, illustrations thereof are omitted in order to focus on the heat sink (the same is applied to the following drawings).

The piping materials 13A, 13B and 13C each have a flow path 9a having a rectangular cross section which is the same size as the flow path 9a of the tube body 9. The piping materials 13A, 13B and 13C are formed of, e.g., copper or a copper alloy. The piping material 13 is connected to the tube body 9 by a brazing filler metal such as silver solder. Connection using silver solder improves reliability against water leakage.

FIG. 2C is a diagram showing an equivalent circuit of a system in the second embodiment. As shown in FIG. 2C, the collector electrode 1a of the semiconductor device 1A as an IGBT and the cathode electrode 1d of the semiconductor device 1B as a FWD are connected to a positive terminal of a DC power supply 20 via the solder 2, the conductor 11 of the laminated body 12A, the electrode body 7A and a wiring 18a. The emitter electrode 1b of the semiconductor device 1A as an IGBT and the anode electrode 1e of the semiconductor device 1B as a FWD are connected to a negative terminal of the DC power supply 20 via the solder 2, the conductor 11 of the laminated body 12B, the electrode body 7B and a wiring 18b. The semiconductor device 1A is operated by inputting a control signal into the gate electrode (illustration omitted).

### Effects of the Second Embodiment

The following effects are obtained by the second embodiment.

(a) If the piping material 13 is pre-bonded using a brazing filler metal having a melting point higher than the temperature during solder bonding of the semiconductor device 1, the piping material 13 does not come off from the joint at the time of soldering the semiconductor device 1, hence, that achieves the stability in the manufacturing

(b) Furthermore, it is possible to bond the piping material 13 and the semiconductor device 1 at a time if the same solder material is used for bonding, which allows lower cost production

(c) In addition, a solder bonding surface can be limited to only a portion where the semiconductor device 1 is bonded to the conductor 11, which improves reliability against solder cracks as compared to the conventional technique

(d) Since there is no need to apply a heat-transfer grease to a heat dissipation path, cooling performance is improved and assembling stability is also improved

(e) It is possible to simplify and shorten the heat dissipation path as compared to the conventional structure, and it is thus possible to improve performance

### Third Embodiment

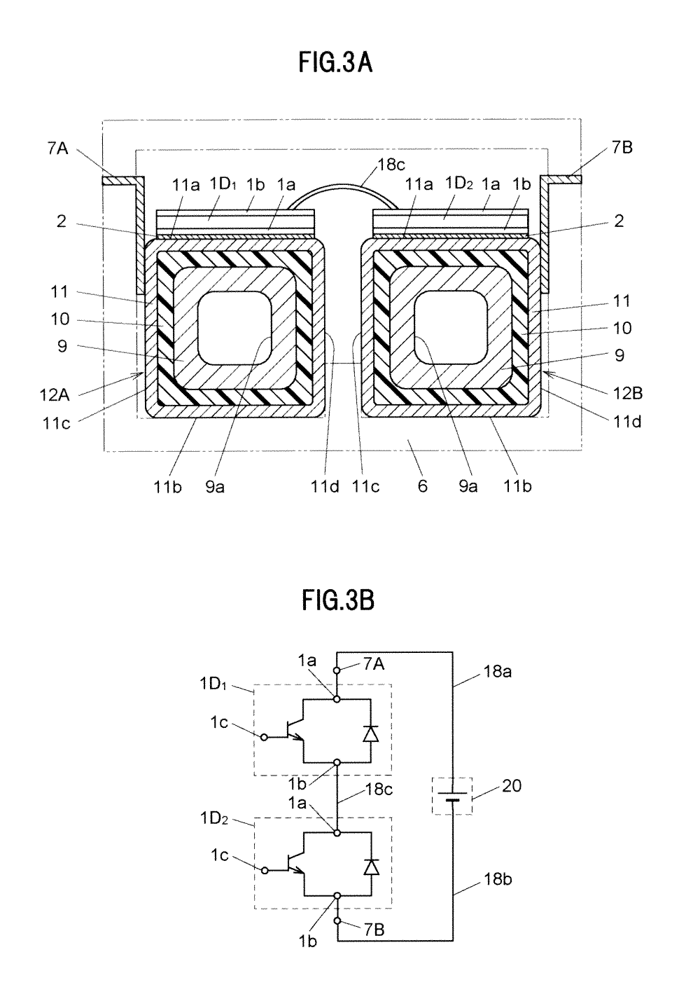

FIG. 3A is a schematic cross sectional view showing a heat sink in the third embodiment of the invention.

In the third embodiment, the semiconductor device 1A is arranged on the upper surface 11a of one laminated body 12A and the semiconductor device 1B is arranged on the upper surface 11a of another laminated body 12B, while the semiconductor devices 1A and 1B are arranged between a pair of laminated bodies 12A and 12B in the second embodiment. In other words, while the second embodiment is to provide heat dissipation paths on both upper and lower surfaces of the semiconductor devices 1A and 1B, the third embodiment is to provide a heat dissipation path on a lower surface of semiconductor devices 1D₁ and 1D₂. The reference numeral 18c in FIG. 3A is a bonding wire.

FIG. 3B is a diagram showing an equivalent circuit of a system in the third embodiment. As shown in FIG. 3B, for example, an IGBT and a FWD are integrated into one chip and used as the semiconductor devices 1D₁ and 1D₂. The collector electrode 1a of the semiconductor device 1D₁ is connected to a positive terminal of the DC power supply 20 via the solder 2, the conductor 11 of the laminated body 12A, the electrode body 7A and the wiring 18a. Meanwhile, the emitter electrode 1b of the semiconductor device 1D₁ is connected to the collector electrode 1a of the semiconductor device 1D₂ via the wire bonding 18c. The emitter electrode 1b of the semiconductor device 1D₂ is connected to the negative terminal of the DC power supply 20 via the solder 2, the conductor 11 of the laminated body 12B, the electrode body 7B and a wiring 18b. In other words, the semiconductor devices 1D₁ and 1D₂ are connected in series.

Although the third embodiment is disadvantageous in cooling performance compared to the second embodiment, the use application of the laminated body 12 for cooling down and applying voltage is the same as the second embodiment, and it is possible to obtain an effect equivalent to that of the second embodiment.

### Fourth Embodiment

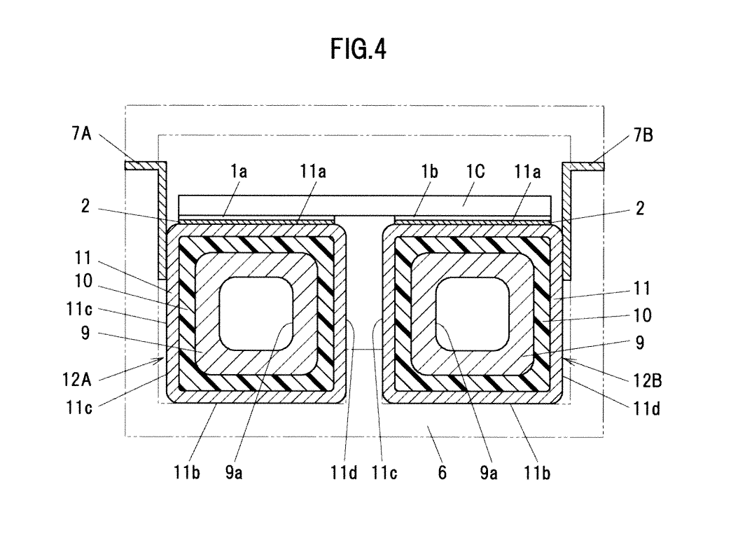

FIG. 4 is a schematic cross sectional view showing a heat sink in the fourth embodiment of the invention. A semiconductor device 1C is arranged so as to straddle between a pair of laminated bodies 12A and 12B in the fourth embodiment while the semiconductor devices 1A and 1B are arranged on respective upper surfaces of a pair of laminated bodies 12A and 12B in the third embodiment.

The semiconductor device 1C in the fourth embodiment has a collector electrode 1a and an emitter electrode 1b on a lower surface thereof.

It is possible to use one or both of the upper and lower surfaces of the semiconductor device to cool down in accordance with a position of an electrode of the semiconductor device such as the case of having the electrodes 1a, 1b, 1d and 1e on the both surfaces of the semiconductor devices 1A and 1B as shown in FIG. 2 or the case of having the electrodes 1a and 1b on the lower surface of the semiconductor device 1C as is the fourth embodiment.

Alternatively, by taking advantage of insulation between the conductor 11 as an outer layer and the tube body 9, the laminated body 12 may be placed on an arbitrary surface of the semiconductor device 1, regardless of the position of the electrode, to efficiently cool down. For example, some of the laminated bodies 12 may not concurrently serve to apply voltage.

### Fifth Embodiment

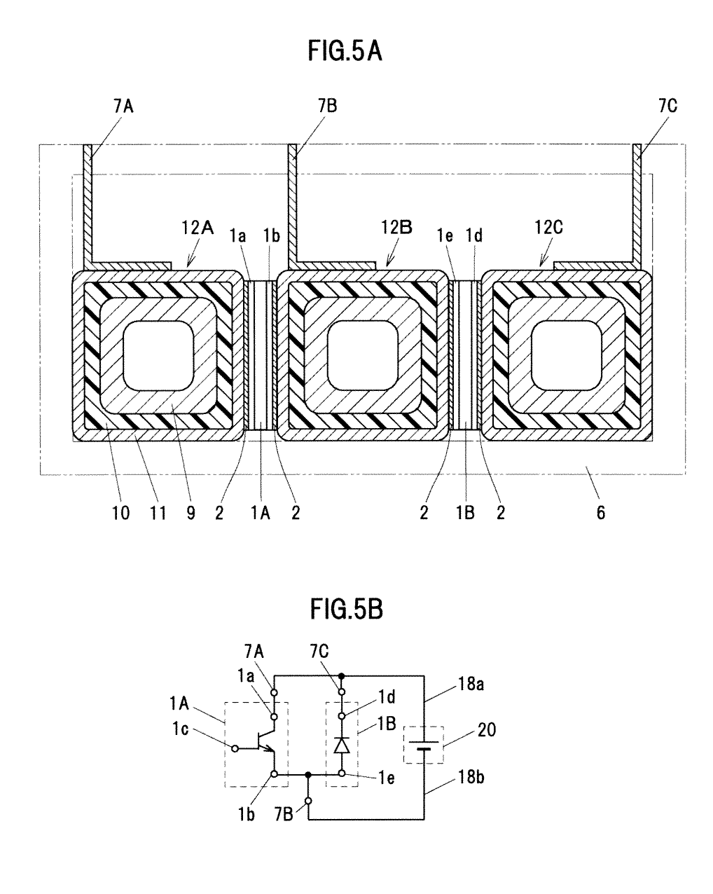

FIG. 5A is a schematic cross sectional view showing a heat sink in the fifth embodiment of the invention. In the fifth embodiment, three laminated bodies 12A, 12B and 12C are arranged in parallel and two semiconductor devices 1A and 1B are arranged between the laminated bodies 12A, 12B and 12C.

In the fifth embodiment, the semiconductor device 1A as an IGBT is arranged between the laminated body 12A located on the left in FIG. 5A and the laminated body 12B located in the middle, and the semiconductor device 1B as a FWD is arranged between the laminated body 12B located in the middle and the laminated body 12C located on the right.

The collector electrode 1a of the semiconductor device 1A as an IGBT is connected to the conductor 11 of the left laminated body 12A by the solder 2, and the emitter electrode 1b of the semiconductor device 1A is connected to the conductor 11 of the middle laminated body 12B by the solder 2.

The anode electrode 1e of the semiconductor device 1B as a FWD is connected to the conductor 11 of the middle laminated body 12B by the solder 2, and the cathode electrode 1d of the semiconductor device 1B is connected to the conductor 11 of the right laminated body 12C by the solder 2

FIG. 5B is a diagram showing an equivalent circuit of a system in the fifth embodiment. The collector electrode 1a of the semiconductor device 1A as an IGBT is connected to the positive terminal of the DC power supply 20 via the solder 2, the conductor 11 of the laminated body 12A, the electrode body 7A and the wiring 18a. The emitter electrode 1b of the semiconductor device 1A is connected to the negative terminal of the DC power supply 20 via the solder 2, the conductor 11 of the laminated body 12B, the electrode body 7B and the wiring 18b.

The cathode electrode 1d of the semiconductor device 1B as a FWD is connected to the positive terminal of the DC power supply 20 via the solder 2, the conductor 11 of the laminated body 12C, the electrode body 7C and the wiring 18a. The anode electrode 1e of the semiconductor device 1B is connected to the negative terminal of the DC power supply 20 via the solder 2, the conductor 11 of the laminated body 12B, the electrode body 7B and the wiring 18b.

### Effects of the Fifth Embodiment

According to the fifth embodiment, when forming a circuit of a semiconductor device such that electrodes of the devices are electrically conducted, it is possible to configure the middle laminated body 12B to concurrently serve as electrodes of two semiconductor devices 1A and 1B.

The case of using two semiconductor devices 1 has been described in the fifth embodiment, however, the fifth embodiment is applicable to the case where three or more semiconductor devices 1 are used.

### Sixth Embodiment

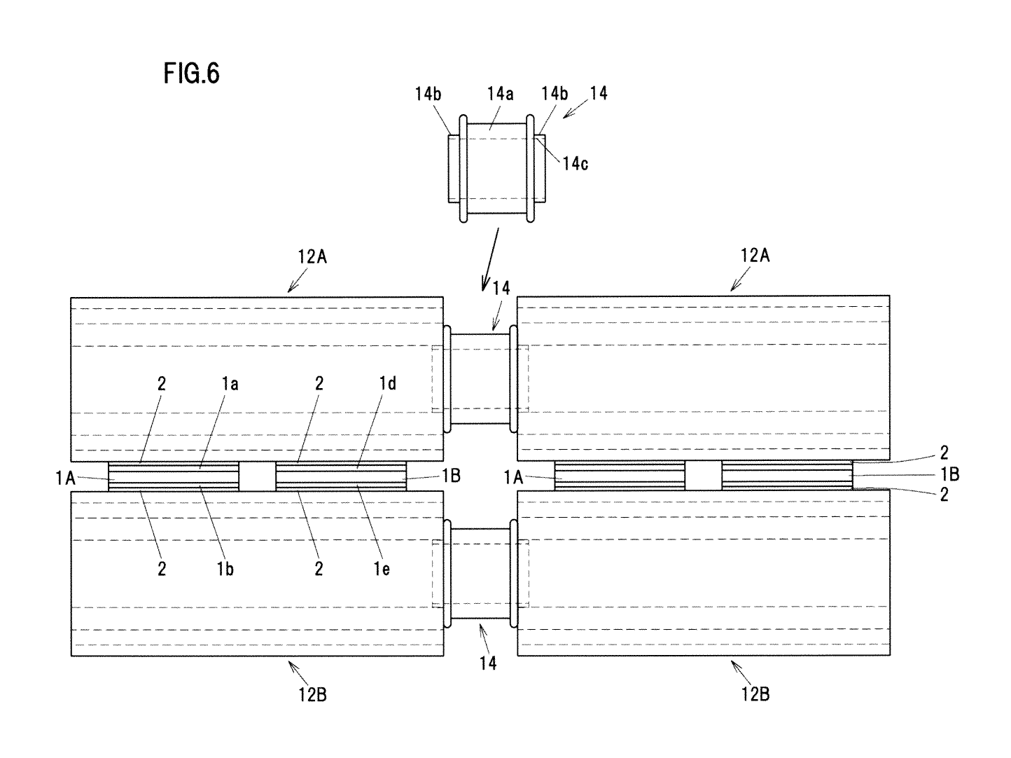

FIG. 6 is a schematic plan view showing a heat sink in the sixth embodiment of the invention. Note that, illustrations of electrode bodies, a case and piping materials are omitted in FIG. 6. In the sixth embodiment, two pairs of parallel-arranged laminated bodies are longitudinally coupled.

In the sixth embodiment, two pairs of parallel-arranged laminated bodies 12A and 12B which are shown in FIG. 2 are longitudinally coupled by couplers 14. Two semiconductor devices 1A and 1B are arranged between each pair of laminated bodies 12A and 12B in the same manner as the second embodiment. The laminated body 12 is connected to the semiconductor device 1 by the solder 2 in the same manner as the previous embodiments.

The coupler 14 is provided with a large diameter portion 14a having an outer diameter larger than an inner diameter of the flow path 9a of the tube body 9 and a small diameter portion 14b which is provided at both ends of the large diameter portion 14a and has an outer diameter slightly smaller than the inner diameter of the flow path 9a of the tube body 9, and then, a flow path 14c having a rectangular cross section is formed therein along an axial direction. The small diameter portion 14b is inserted into the flow path 9a of the tube body 9 and the coupler 14 is coupled to the laminated body 12A by brazing using silver solder, etc.

The following effects are obtained by the sixth embodiment

(a) It is applicable to the case where a pair of semiconductor devices 1A and 1B are electrically insulated from another pair of semiconductor devices 1A and 1B

(b) If the coupler 14 is pre-bonded using a brazing filler metal having a melting point higher than the temperature during solder bonding of the semiconductor device 1, the coupler 14 does not come off from the joint at the time of soldering the semiconductor device 1, hence, that achieves the stability in the manufacturing

(c) Furthermore, it is possible to bond the coupler 14 and the semiconductor device 1 at a time if the same solder material is used for bonding, which allows lower cost production.

### Seventh Embodiment

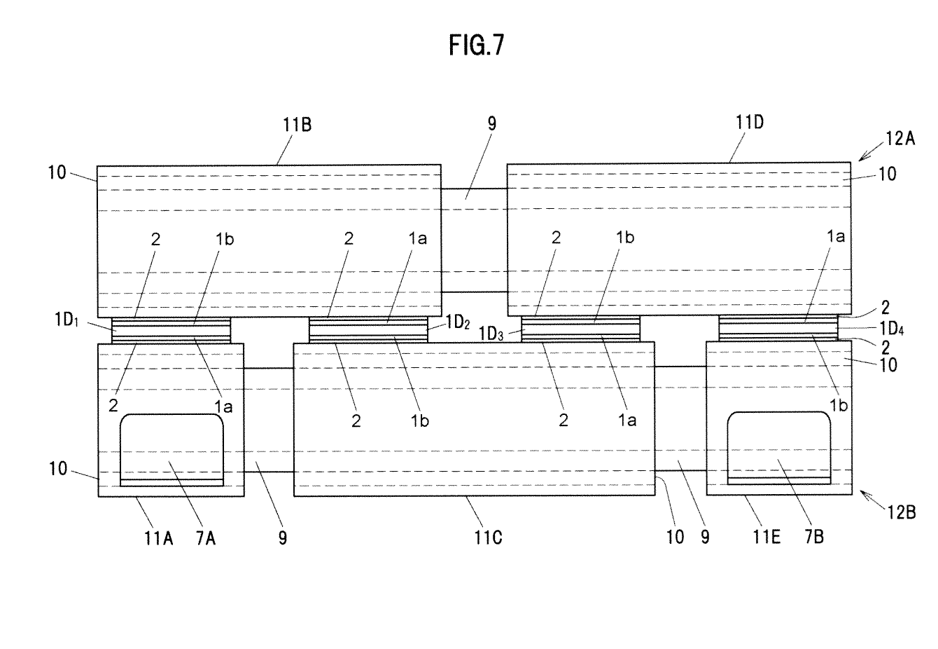

FIG. 7 is a schematic plan view showing a heat sink in the seventh embodiment of the invention. Note that, illustrations of a case and piping materials are omitted in FIG. 7. In the seventh embodiment, the conductors 11 of the pair of parallel-arranged laminated bodies 12A and 12B are partially removed at predetermined positions and plural semiconductor devices 1 are arranged between the remained conductors 11 of the pair of laminated bodies 12A and 12B so as to be connected in series.

In the seventh embodiment, each of the laminated bodies 12A and 12B is provided along a longitudinal direction and has plural conductors 11 which are electrically insulated from each other. That is, the laminated body 12A has plural conductors 11B and 11D which are electrically insulated from each other. The laminated body 12B has plural conductors 11A, 11C and 11E which are electrically insulated from each other. The two laminated bodies 12A and 12B are arranged in parallel and plural semiconductor devices 1D (1D₁ to 1D₄) are arranged between the two laminated bodies 12A and 12B.

For example, an IGBT and a FWD are integrated into one chip and used as the semiconductor devices 1D₁ to 1D₄.

As for the semiconductor device 1D₁, the collector electrode 1a is connected to the conductor 11A of the laminated body 12B by the solder 2 and the emitter electrode 1b is connected to the conductor 11B of the laminated body 12A by the solder 2.

As for the semiconductor device 1D₂, the collector electrode 1a is connected to the conductor 11B of the laminated body 12A by the solder 2 and the emitter electrode 1b is connected to the conductor 11C of the laminated body 12B by the solder 2.

As for the semiconductor device 1D₃, the collector electrode 1a is connected to the conductor 11C of the laminated body 12B by the solder 2 and the emitter electrode 1b is connected to the conductor 11D of the laminated body 12A by the solder 2.

As for the semiconductor device 1D₄, the collector electrode 1a is connected to the conductor 11D of the laminated body 12A by the solder 2 and the emitter electrode 1b is connected to the conductor 11E of the laminated body 12B by the solder 2.

The semiconductor devices 1D₁ to 1D₄ are connected as described above and are thus connected in series. In addition, the collector electrode 1a of the semiconductor device 1D₁ is connected to a positive terminal of a DC power supply via the solder 2, the conductor 11A of the laminated body 12B, the electrode body 7A and a wiring, and the emitter electrode 1b of the semiconductor device 1D₄ is connected to a negative terminal of the DC power supply via the solder 2, the conductor 11E of the laminated body 12B, the electrode body 7B and a wiring.

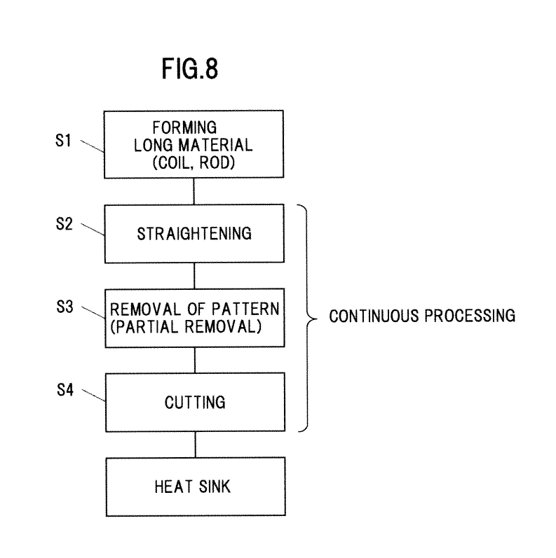

FIG. 8 is a process chart schematically showing a process of removing a conductor. An elongated laminated body (an elongated material) of 60 m or more is formed by performing a drawing process as described in the first embodiment (S1). In this case, the elongated material may be in a form of coil or rod.

Next, the elongated laminated body is straightened by a straightening machine (S2). Following this, the conductor 11 is partially removed by a machining tool (S3). Then, the laminated body is cut into a required length by a cutting machine (S4).

The above-mentioned steps S1, S2, S3 and S4 allow a continuous process of a workpiece by aligning a drawing machine, a straightening machine, a machining tool and a cutting machine and also providing feeding mechanisms therebetween, and thus allow low cost production of heat sink. Alternatively, a machining center may be used in the steps of machining and cutting.

### Effects of the Seventh Embodiment

The following effects are obtained by the seventh embodiment.

(a) It is possible to provide an electrically insulated portion at an arbitrary position by partially removing an outer conductor portion of the laminated body 12 at a predetermined position, which allows an electric circuit to be composed in a combination of the semiconductor device 1 and the partially removed laminated body 12.

(b) Since it is possible to form an elongated laminated body 12 by the drawing process, the present structure can be realized by preliminarily preparing a laminated body equal to the whole length and then removing a predetermined portion, which allows low cost production.

Although the insulation layer is removed together with the outer conductor in the seventh embodiment, the insulation layer may be left while removing only the conductor.

### Eighth Embodiment

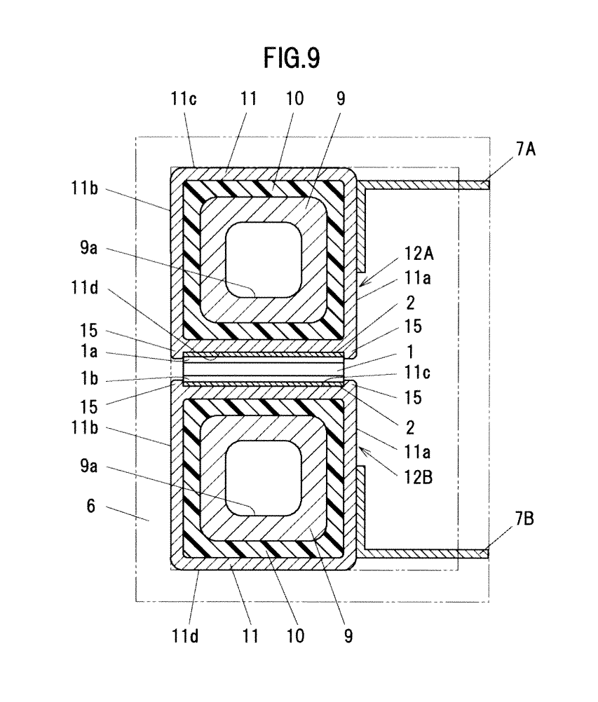

FIG. 9 is a schematic cross sectional view showing a heat sink in the eighth embodiment of the invention. The eighth embodiment is a modification of the second embodiment shown in FIG. 2.

In the eighth embodiment, a pair of protrusions 15 are provided along a longitudinal direction on the surfaces of the conductors 11 of the laminated bodies 12A and 12B on which the semiconductor devices 1A and 1B are arranged. A gap between the pair of protrusions 15 is equivalent to widths of the semiconductor devices 1A and 1B. The protrusion 15 may be formed by a machining process such as cutting work, or alternatively may be formed during the drawing process of the laminated body. A drawing die having a cross sectional shape with protrusions is used in order to form the protrusion 15 in the drawing process. In addition, when the protrusion 15 is formed by the drawing process, a width of the semiconductor device 1A needs to be the same as that of the semiconductor device 1B.

### Effects of the eighth embodiment

The following effects are obtained by the eighth embodiment.

(a) Since the semiconductor device 1 can be positioned by the protrusion 15 at the time of solder bonding the laminated body 12 to the semiconductor device 1, it is possible to easily fix the semiconductor device 1 at a predetermined position.

(b) Since the drawing process allows to form an elongated laminated body 12 having the protrusion 15, it is possible to obtain the laminated body 12 having the protrusion 15 at low cost without adding a processes for forming a protrusion.

It should be noted that the shape of the protrusion is not limited to the shape shown in FIG. 9, and it is possible to form an arbitrary shape by arbitrarily determining a cross sectional shape of the drawing die.

### Ninth Embodiment

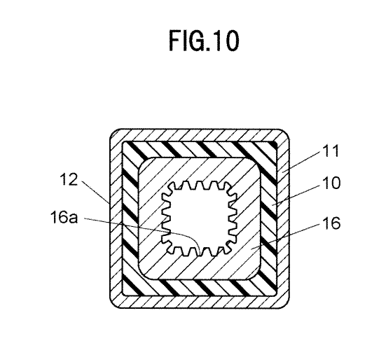

FIG. 10 is a cross sectional view showing a laminated body of a heat sink in the ninth embodiment of the invention. Although FIG. 10 only shows the laminated body 12, the laminated body 12 is bonded to a semiconductor device and is concurrently used as an electrode as well as a heat sink in the same manner as the previous embodiments.

In the laminated body 12 of the ninth embodiment, a groove 16a is formed on an inner surface of a tube body 16. The groove 16a has, e.g., a helical shape. It is possible to form the groove 16a by the drawing process of the laminated body.

The following effects are obtained by the ninth embodiment.

(a) The use of the internally grooved tube 16 as a tube body improves heat-transfer coefficient to the refrigerant in the flow path, and thus improves cooling performance.

(b) Since the internally grooved tube is widely used for an air conditioner heat exchanger, etc., it can be used without largely increasing the cost.

(c) Since the drawing process of the laminated body 12 allows production without adding any processes, the cost is not increased.

### Tenth Embodiment

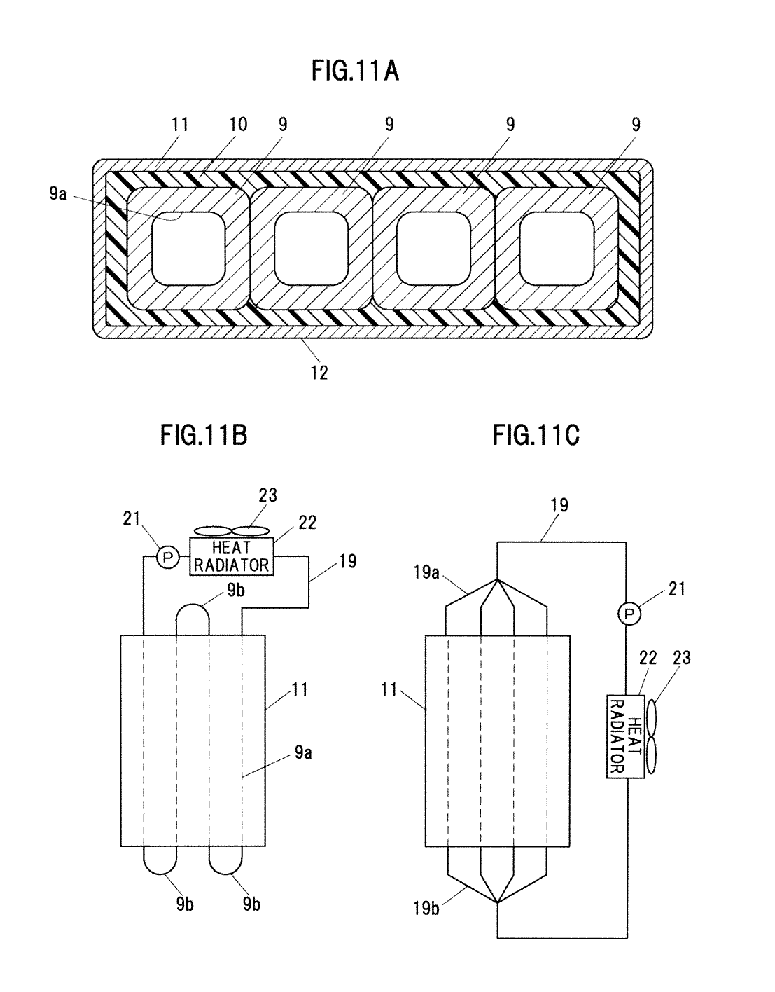

FIG. 11A is a schematic cross sectional view showing a heat sink in the tenth embodiment of the invention. Although FIG. 11A only shows the laminated body 12, the laminated body 12 is bonded to a semiconductor device and is concurrently used as an electrode as well as a heat sink in the same manner as the previous embodiments.

In the tenth embodiment, the laminated body 12 is provided with plural tube bodies 9 (four in the tenth embodiment) having plural flow paths 9a (four in the tenth embodiment), a single insulation layer 10 formed around the plural tube bodies 9 and a conductor 11 formed around the single insulation layer 10.

In the tenth embodiment, for example, plural tube bodies 9 are preliminarily inserted into an insulator in the drawing process of the laminated body 12 to manufacture the laminated body 12 having the present structure.

FIG. 11B is a view showing a flow path structure of a system in the tenth embodiment. FIG. 11B shows a configuration in which four flow paths 9a in the laminated body 12 are connected by arc-shaped piping materials 9b so as to form a through-flow. The refrigerant which is pressure-fed from a pump 21 passes through the flow paths 9a in the laminated body 12 to a pipe 19. Heat held by the refrigerant is dissipated by a heat radiator 22 such as aluminum radiator. A cooling fan 23 is provided in the heat radiator 22.

FIG. 11C is a view showing another flow path structure of a system in the tenth embodiment. FIG. 11C shows a configuration in which four flow paths 9a in the laminated body 12 form a parallel flow. The refrigerant which is pressure-fed from the pump 21 is divided at a branched portion 19a and passes through the flow paths 9a in the laminated body 12, a merging portion 19a to the pipe 19. Heat held by the refrigerant is dissipated by a heat radiator 22.

### Effects of the Tenth Embodiment

The following effects are obtained by the tenth embodiment.

(a) The present structure allows to easily obtain a wide laminated body 12 and also can increase an internal area as compared to a tube body having an oval cross section, and thus improves cooling performance.

(b) In addition, it is possible to arbitrarily configure a piping structure of the tube body 9 such as through-flow or parallel flow, etc., and it is thus possible to configure an optimum flow path depending on ability of the pump or the entire pressure loss, which allows improvement in the cooling performance.

### Eleventh Embodiment

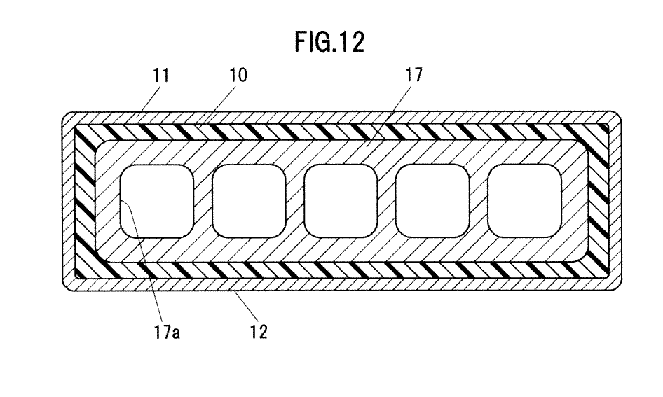

FIG. 12 is a schematic cross sectional view showing a heat sink in the eleventh embodiment of the invention. Although FIG. 12 only shows the laminated body 12, the laminated body 12 is bonded to a semiconductor device and is concurrently used as an electrode as well as a heat sink in the same manner as the previous embodiments.

In the eleventh embodiment, the plural tube bodies 9 shown in FIG. 11A are integrated into a single tube body 9. In other words, in the eleventh embodiment, a laminated body is provided with a single tube body 17 having plural flow paths 17a (five in the eleventh embodiment), a single insulation layer 10 formed around the single tube body 17 and a single conductor 11 formed around the single insulation layer 10.

In the eleventh embodiment, for example, the tube body 17 is preliminarily inserted when the laminated body 12 is manufacture by the drawing process, and it is thus possible to easily obtain the present structure.

The following effects are obtained by the eleventh embodiment.

(a) The present structure allows to easily obtain a wide laminated body 12 and also can increase an internal area of the flow path, and it is thus possible to improve cooling performance.

(b) Since a perforated pipe is widely used for a heat exchanger, etc., of an aluminum radiator, etc., it is possible to obtain the present structure without increasing the cost.

### Twelfth Embodiment

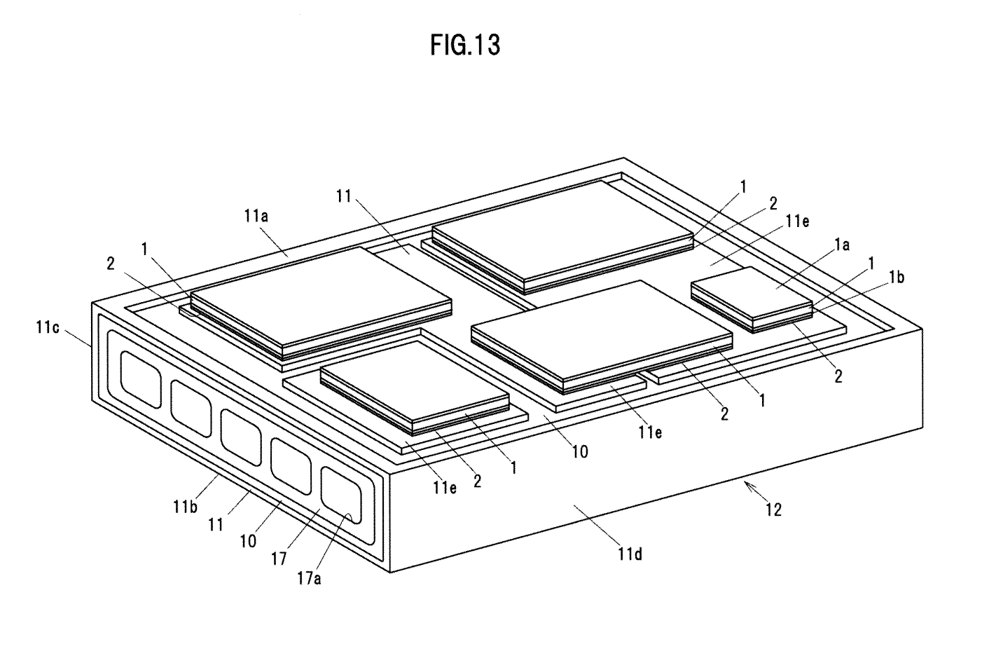

FIG. 13 is a schematic perspective view showing a heat sink in the twelfth embodiment of the invention. Illustrations of electrode bodies and a case are omitted in FIG. 13. In the twelfth embodiment, plural semiconductor devices are arranged on the upper surface of the laminated body 12 of the eleventh embodiment.

In the twelfth embodiment, the laminated body 12 is provided with a single tube body 9 having plural flow paths 9a (five in the twelfth embodiment), a single insulation layer 10 formed around the single tube body 9 and a single conductor 11 formed around the single insulation layer 10, and then, plural semiconductor devices 1 are arranged on the upper surface 11a of the conductor 11. The laminated body has plural conductor regions which are provided on the same surface of the conductor so as to be electrically insulated from each other and each have the bonding surface.

In the conductor 11, plural conductor regions 11e, which are formed by partially removing the upper surface 11a so as to be electrically insulated from each other, are provided on the same upper surface 11a corresponding to the layout of the semiconductor devices 1. It is possible to partially remove the conductor 11 by a machining process such as cutting or chemical treatment such as etching. The previously mentioned process which is shown in FIG. 8 can be used for removing the conductor 11.

The following effects are obtained by the twelfth embodiment.

(a) The semiconductor device 1 is bonded, by the solder 2, to the conductor 11 after pattern removal. This allows the laminated body 12 to be used as a wiring board and it is also possible to efficiently cool the semiconductor device 1.

(b) Although the conductor 11 is partially removed, heat generated by the semiconductor device 1 is transmitted to the tube body 9 via the insulation layer 10 and then to the refrigerant flowing in the flow path 9a of the tube body 9.

Although the laminated body 12 is connected only to the lower surface of the semiconductor device 1 in the twelfth embodiment, the laminated body 12 after pattern removal may be connected to the upper surface of the semiconductor device 1 in the same manner. This improves cooling performance due to heat dissipation from both the upper and lower surfaces, and also allows an electric circuit formed of the conductor 11 to be more complicated, thereby improving general versatility.

It should be noted that the present invention is not intended to be limited to the above-mentioned embodiments, and the various kinds of modifications can be implemented without departing from the gist of the present invention.

What is claimed is:

1. A heat sink, comprising:
a laminated body disposed in a flow path for circulating a refrigerant,
wherein the laminated body comprises a metallic tube body enclosing the flow path therein, an insulation layer formed on a periphery of the tube body, and a conductor that is formed on a periphery of the insulation layer and comprises a bonding surface bonded to an electrode of a semiconductor device to be cooled.

2. The heat sink according to claim 1, further comprising:
an electrode body that is attached to a surface of the conductor and electrically connected to the semiconductor device via the conductor.

3. The heat sink according to claim 1, wherein a plurality of the laminated bodies are arranged in parallel.

4. The heat sink according to claim 3, wherein the plurality of the laminated bodies comprise the bonding surface on an opposite side of a pair of the conductors.

5. The heat sink according to claim 3, wherein the plurality of the laminated bodies comprise the bonding surface on a same side of the conductors.

6. The heat sink according to claim 1, wherein the laminated body comprises a plurality of the conductors arranged along a longitudinal direction thereof and electrically insulated from each other.

7. The heat sink according to claim 1, wherein the laminated body comprises a plurality of conductor regions that are provided on a same side of the conductor and electrically insulated from each other, the plurality of conductor regions each comprising the bonding surface.

8. The heat sink according to claim 1, wherein the tube body is an internally grooved tube.

9. The heat sink according to claim 1, wherein the laminated body comprises a plurality of the tube bodies disposed in a plurality of the flow paths, the single insulation layer formed on the periphery of the plurality of the tube bodies, and the conductor formed on the periphery of the single insulation layer.

10. The heat sink according to claim 1, wherein the laminated body comprises the single tube body disposed in a plurality of flow paths, the single insulation layer formed on the periphery of the single tube body, and the single conductor formed on the periphery of the single insulation layer.

11. A method of manufacturing a heat sink, comprising:
forming an elongated laminated body through a drawing process, the laminated body comprising a metallic tube body enclosing a flow path therein, an insulation layer formed on a periphery of the tube body and a conductor formed on a periphery of the insulating layer;
removing a portion of the conductor; and
cutting the elongated laminated body.
